(19) United States
(12) Patent Application Publication
(10) Pub. No.: US 2015/0111414 A1
(43) Pub. Date: Apr. 23, 2015

(54) LEVER TYPE CONNECTOR

(71) Applicant: Yazaki Corporation, Minato-ku, Tokyo (JP)

(72) Inventor: Jun Kamiya, Toyota-shi (JP)

(73) Assignee: Yazaki Corporation, Minato-ku, Tokyo (JP)

(21) Appl. No.: 14/398,344

(22) PCT Filed: May 8, 2013
(86) PCT No.: PCT/JP2013/063473

§ 371 Date: Oct. 31, 2014

(30) Foreign Application Priority Data
May 9, 2012 (JP) 2012-107891

(51) Int. Cl. H01R 13/629

(52) U.S. Cl. CPC H01R 13/62955
USPC 439/372

(57) ABSTRACT

When the connector housings are positioned to a fitting operation start position and the fitting operation lever 30 on the second connector housing 20 is rotated, the second support recessed parts 22 send out fulcrum shafts 33 of the fitting operation lever 30 to the first support recessed parts 12. When the connector housings are completely fitted and connected to each other by a rotating operation of the fitting operation lever 30, the first support recessed parts 12 detach the fitting operation lever 30 form the connector housing.

### TECHNICAL FIELD

The present invention relates to a lever type connector.

### BACKGROUND ART

FIG. 20 shows a usual example of the lever type connector.

This lever type connector 100 is disclosed in below-described PTL 1 and includes a first connector housing 110, a second connector housing 120 fitted and connected to the first connector housing 110 and a fitting operation lever 130 rotatably attached to the first connector housing 110.

The second connector housing 120 has an outer tubular wall part (hood part) 1121 into which the first connector housing 110 is inserted.

The fitting operation lever 130 is rotatably attached to boss parts 1111 which protrude on outer side surfaces of the first connector housing 110 as a lever member that reduces an operating force during a fitting operation and a releasing operation of a fitted state of the first connector housing 110 and the second connector housing 120.

As shown in the drawing, the fitting operation lever 130 includes one pair of lever main bodies 131 opposed to each other and arranged so as to hold one pair of outer side surfaces of the first connector housing 110, a connecting member 132 which connects one end sides of the one pair of lever main bodies 131 to each other, rotation fulcrum holes 133 formed on the lever main bodies 131 so as to rotatably engage with the boss parts 1111 on the outer side surfaces of the first connector housing 110 and protrusions 134 for operating points which are engaged with lever engaging holes 1122 formed on outer side surfaces of the outer tubular wall part 1121 at the time of a start of a fitting operation when the first connector housing 110 and the second connector housing 120 are positioned to a fitting operation start position.

In the example shown in the drawing, the connecting member 132 simultaneously serves as a point of force part which receives the operating force when the lever main bodies 131 are rotated on the boss parts 1111 as a center of rotation.

In the lever type connector 100 of the PTL 1, the first connector housing 110 is fitted and connected to the second connector housing 120 by a below-described procedure.

Initially, as shown in the drawing, the fitting operation lever 130 is rotatably attached to the first connector housing 110. Then, as shown by an arrow mark X1 in the drawing, an end part of the first connector housing 110 is inserted into the outer tubular wall part 1121 of the second connector housing 120 to position the first connector housing 110 and the second connector housing 120 to the fitting operation start position. Then, the protrusions 134 for the operating points of the fitting operation lever 130 are engaged with the lever engaging holes 1122 of the second connector housing 120.

Subsequently, the connecting member 132 of the fitting operation lever 130 is pushed downward to rotate the fitting operation lever 130 as shown by an arrow mark R1 in the drawing. In accordance with the rotating operation of the fitting operation lever 130, the second connector housing 120 is pulled toward the first connector housing 110 side. Thus, the connector housings are completely fitted to each other.

When the fitted state of the connector housings is released, the connecting member 132 is rotated in an opposite direction to the direction shown by the arrow mark R1 in FIG. 20, so that the connector housings are separated from each other.

### CITATION LIST

### Patent Literature

[PTL 1] Japanese Patent No. 3442661

### SUMMARY OF INVENTION

### Technical Problem

However, in the case of the lever type connector 100 of the PTL 1, under a state that the connector housings are fitted and connected to each other, the fitting operation lever 130 cannot be detached from the first connector housing 110.

Accordingly, in the case of the lever type connector 100 of the PTL 1, even in an actual using state that the connector housings are completely fitted and connected to each other, the weight of the fitting operation lever 130 is added, which is a factor to increase the weight of the connector.

Further, in the case of the lever type connector 100 of the PTL 1, since the fitting operation lever 130 necessarily has to be attached to the lever type connector 100, there is a possibility in that a cost is increased due to an increase of the number of parts.

The present invention has been conceived in light of the circumstance, and it is an object of the present invention to provide a lever type connector which can realize a reduction of cost due to a decrease of the number of parts and a reduction of weight in a state of use.

### Solution to Problem

In order to achieve the object of the present invention, the present invention provides with is a below-described structure.

(1) A lever type connector including:

a first connector housing;

a second connector housing fitted and connected to the first connector housing; and

a fitting operation lever rotatably attached to the first connector housing as a lever member which reduces an operation force during a fitting operation and a releasing operation of a fitted state of the first connector housing and the second connector housing,

wherein the first connector housing includes:

an outer tubular wall part (a hood part) fitted to an outer periphery of the second connector housing;

first support recessed parts formed and cut out so as to insert therein outer end parts of fulcrum shafts of the fitting operation lever in one end sides in a direction intersecting at right angles to a direction where one pair of side walls are opposed to each other on end edges of the one pair of side walls of the outer tubular wall part which are opposed to each other, and having in their interiors first shaft guide surfaces on which the inserted fulcrum shafts rotatably abut; and

a locking engagement part provided on one or a plurality of inner side surfaces of the outer tubular wall part and engaged with the second connector housing when a fitting and connecting operation of the first connector housing and the second connector housing is completed to lock the connected state of the connector housings,

the second connector housing includes:

second support recessed parts formed to be recessed so as to insert therein inner end parts of the fulcrum shafts of the fitting operation lever on one pair of outer side walls which face inner surfaces of the one pair of side walls provided with the first support recessed parts, having second shaft guide surfaces formed to be recessed in directions opposed to the first support recessed parts on which the inner end parts of the inserted fulcrum shafts rotatably abut, and in which when the second connector housing is positioned to a fitting operation start position to the first connector housing under a state that the inner end parts of the fulcrum shafts are allowed to abut on the second shaft guide surfaces, the outer end parts of the fulcrum shafts are inserted into the first support recessed parts;

an engagement receiving part engaged with the locking engagement part when the fitting and connecting operation of the first connector housing and the second connector housing is completed to lock the connected state of the connector housings; and

operation receiving boss parts protruding at positions spaced by prescribed distances from the second support recessed parts in a direction intersecting at right angles to a direction where the one pair of outer side walls are opposed to each other on surfaces of the one pair of outer side walls, and on which side edges of lever main bodies of the fitting operation lever abut when the fitting operation lever rotatably supported in the first support recessed parts is rotated in a prescribed direction to receive a force in a fitting direction of the connector housings from the fitting operation lever,

the fitting operation lever includes:

one pair of lever main bodies arranged and opposed to each other so as to be inserted into gaps between the one pair of side walls of the first connector housing and the one pair of outer side walls of the second connector housing, and having their side edges abutting on the operation receiving boss parts of the second connector housing attached to the first connector housing when the lever main bodies are rotated in a prescribed direction on the first support recessed parts as supporting points with ends rotatably supported by the first support recessed parts to apply the force in the fitting direction of the connector housings; and

the fulcrum shafts including the outer end parts protruding toward the side walls of the first connector housing from the ends of the lever main bodies so as to be inserted into the first support recessed parts and the inner end parts protruding toward the outer side walls of the second connector housing from the ends of the lever main bodies so as to be inserted into the second support recessed parts,

the second shaft guide surfaces in the second support recessed parts have second inclined surfaces which send out the fulcrum shafts to the first shaft guide surfaces by a force applied to abutting parts from the inner end parts of the fulcrum shafts when the fitting operation lever receives a rotating and operating force in a prescribed direction and rotates on the operation receiving boss parts as supporting points to allow the fulcrum shafts to rotatably abut on the first shaft guide surfaces, and

the first shaft guide surfaces of the first support recessed parts have first inclined surfaces which support the fulcrum shafts as supporting points of rotation of levers and allow the lever main bodies to function as lever members when the fitting operation lever receives a rotating and operating force in a prescribed direction, and send out the fulcrum shafts outside the first support recessed parts in accordance with a rotation applied to the fitting operation lever after the fitting and connecting operation of the connector housings is completed by the rotating operation of the fitting operation lever to detach the fitting operation lever from the first connector housing.

According to the structure of the above-described (1), as an operating procedure for fitting and connecting the connector housings to each other, initially, the inner end parts of the fulcrum shafts of the fitting operation lever are inserted into the second support recessed parts of the second connector housing to attach the fitting operation lever to the connector housing.

Then, the second connector housing to which the fitting operation lever is attached, and the first connector housing are positioned to the fitting operation start position.

Then, the outer end parts of the fulcrum shafts of the fitting operation lever are inserted into the first support recessed parts of the first connector housing. However, at that time, the outer end parts of the fulcrum shafts are separated from the first shaft guide surfaces.

Then, when the fitting operation lever is started to rotate in a prescribed direction, the fitting operation lever swings on the operation receiving boss parts provided on the second connector housing as supporting points on which the side edges of the lever main bodies abut. At that time, the second inclined surfaces of the second shaft guide surfaces which receive an operating force from the fulcrum shafts send out the fulcrum shafts to the first shaft guide surfaces of the first support recessed parts opposed thereto. In accordance with the sending operation by the second inclined surfaces, the fulcrum shafts rotatably abut on the first shaft guide surfaces. Accordingly, the fitting operation lever operates as a lever having the first shaft guide surfaces of the first support recessed parts as supporting points of rotation by the operating force inputted to the fitting operation lever and applies the force in the fitting direction to the operation receiving boss parts on the second connector housing to fit and connect the connector housings to each other.

Then, when the fitting and connecting operation of the connector housings is completed by the rotating operation of the fitting operation lever, the engagement receiving part of the second connector housing is engaged with the locking engagement part of the first connector housing to lock the fitted and connected state of the connector housings.

After the connector housings are completely fitted and connected to each other, when the fitting operation lever is further rotated, the fulcrum shafts of the fitting operation lever move toward the opening part sides of the first support recessed parts along the first inclined surfaces of the first support recessed parts. In accordance with a movement along the first inclined surfaces, the fulcrum shafts are sent outside the first support recessed parts. Thus, the fitting operation lever is detached from the connector housing.

Namely, according to the structure of the above-described (1), after the fitting and connecting operation of the connector housings is completed by the rotating operation of the fitting operation lever, the fitting operation lever is further pressed to the rotating direction, so that the fitting operation lever is automatically detached from the connector housings. Accordingly, under a state that the connector is used, the weight of the fitting operation lever is not applied. Thus, the weight of the connector can be reduced when the connector is used.

Further, since the fitting operation lever detached from the connector housings can be properly used for fitting operations of other lever type connectors. Accordingly, as a parts set of an ordinary fitting operation lever, only the first connector housing and the second connector housing are used by excluding the fitting operation lever. Thus, a cost can be reduced due to a decrease of the number of parts.

### Advantageous Effects of Invention

According to the lever type connector of the present invention, after the fitting and connecting operation of the connector housings is completed, the fitting operation lever is detached from the connector housings. Accordingly, under a state that the connector is used, the weight of the connector can be reduced.

Further, since the fitting operation lever detached from the connector housings can be properly used for fitting operations of other lever type connectors. Accordingly, as a parts set of an ordinary fitting operation lever, only the first connector housing and the second connector housing are used by excluding the fitting operation lever. Thus, a cost can be reduced due to a decrease of the number of parts.

The present invention is briefly explained as described above. When mode for carrying out the invention (refer it to as an “exemplary embodiment”, hereinafter) which will be described below is read by referring to the attached drawings, a detail of the present invention will be more clarified.

### BRIEF DESCRIPTION OF DRAWINGS

FIG. 1 is an exploded perspective view of one exemplary embodiment of a lever type connector according to the present invention.

FIG. 2 is a side view of a first connector housing shown in FIG. 1.

FIG. 3 is an enlarged view of a part A shown in FIG. 2.

FIG. 4 is a side view of a second connector housing shown in FIG. 1.

FIG. 5 is an enlarged view of a part B shown in FIG. 4.

FIG. 6 is a side view showing a state that the second connector housing to which a fitting operation lever shown in FIG. 1 is attached is opposed to the first connector housing.

FIG. 7 is an enlarged view of a part C shown in FIG. 6.

FIG. 8 is a side view showing a state that the first connector housing and the second connector housing shown in FIG. 6 are positioned to a fitting operation start position.

FIG. 9 is an enlarged view of a part D shown in FIG. 8.

FIG. 10 is a side view when a rotating operation of the fitting operation lever is started from the state shown in FIG. 8 and a second inclined surface 222b of a second support recessed part moves a fulcrum shaft of the fitting operation lever to a first shaft guide surface of a first support recessed part.

FIG. 11 is an enlarged view of a part E shown in FIG. 10.

FIG. 12 is a side view showing a state that the rotating operation of the fitting operation lever advances and the fulcrum shaft of the fitting operation lever abuts on the first shaft guide surface of the first support recessed part.

FIG. 13 is an enlarged view of a part F shown in FIG. 12.

FIG. 14 is a side view showing a state that the rotating operation of the fitting operation lever further advances so that the fitting operation lever halfway fits the connector housings to each other as a lever member.

FIG. 15 is an enlarged view of a part G shown in FIG. 14.

FIG. 16 is a side view when the rotating operation of the fitting operation lever furthermore advances so that the connector housings are completely fitted and connected to each other.

FIG. 17 is an enlarged view of a part H shown in FIG. 16.

FIG. 18 is a side view showing a state that after the fitting and connecting operation of the connector housings are completed, a first inclined surface of the first shaft guide surface pushes the fulcrum shaft of the fitting operation lever outside the first support recessed part to detach the fitting operation lever from the connector housings.

FIG. 19 is an enlarged view of a part I shown in FIG. 18.

FIG. 20 is an exploded perspective view of a usual lever type connector.

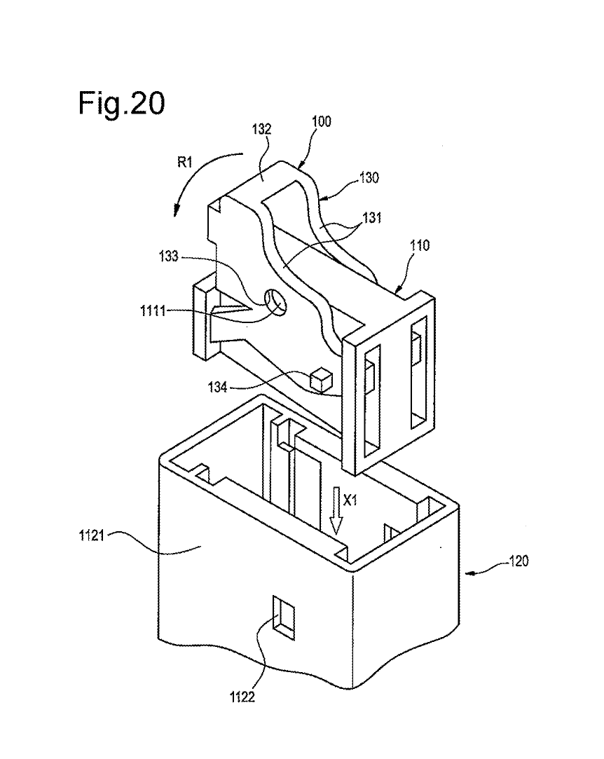

### DESCRIPTION OF EMBODIMENTS

A preferred exemplary embodiment of a lever type connector according to the present invention will be described in detail by referring to the drawings.

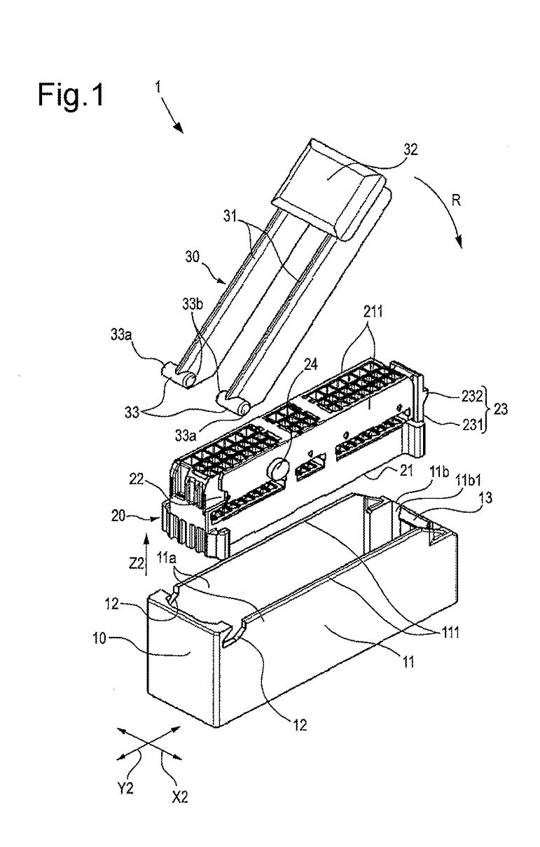

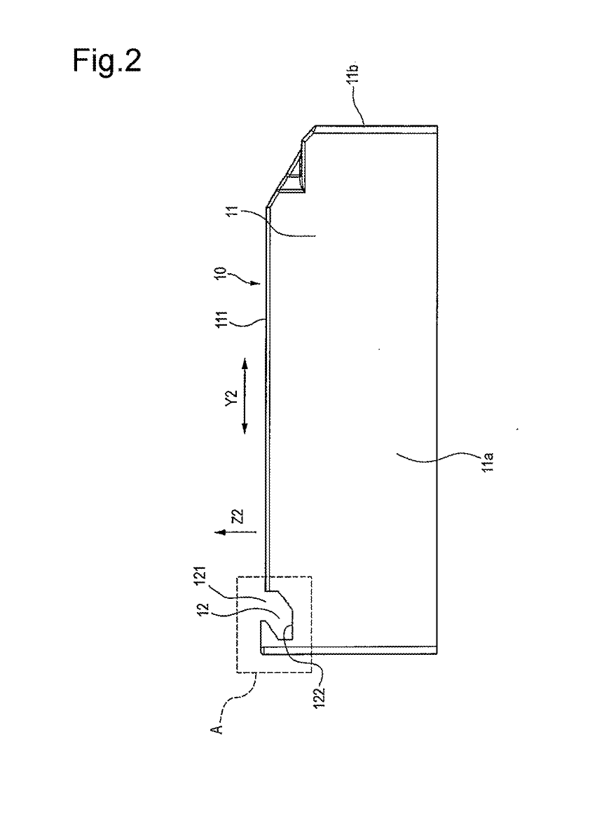

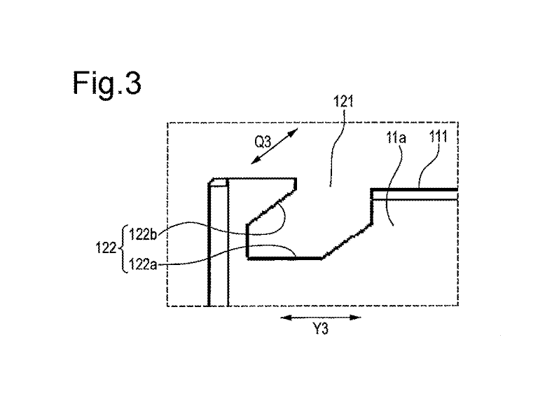

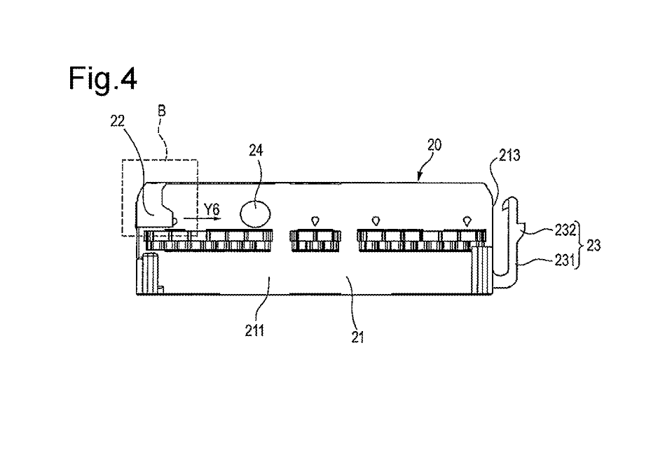

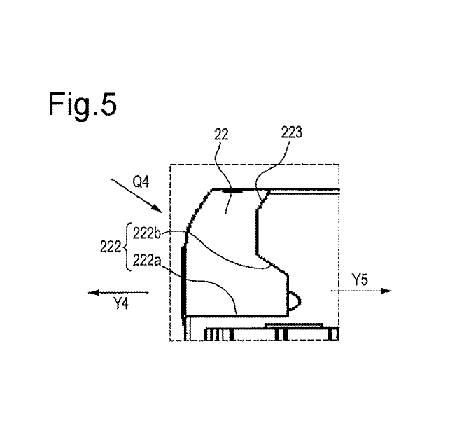

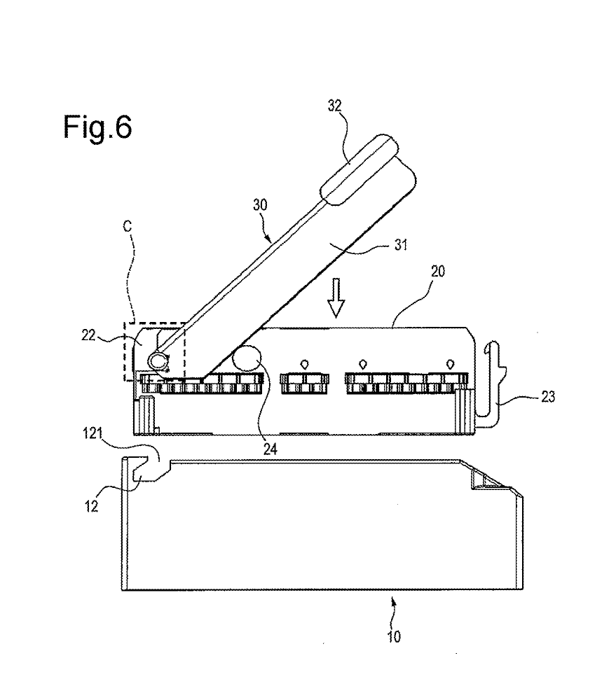

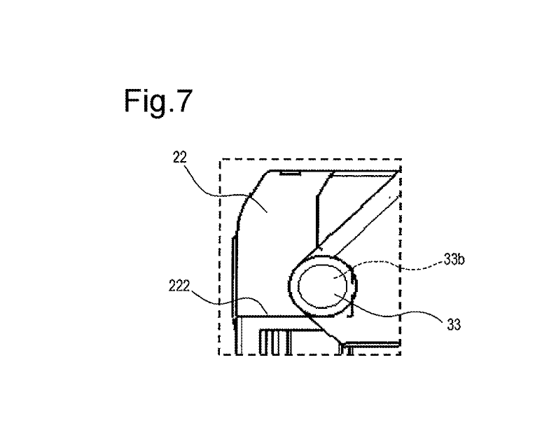

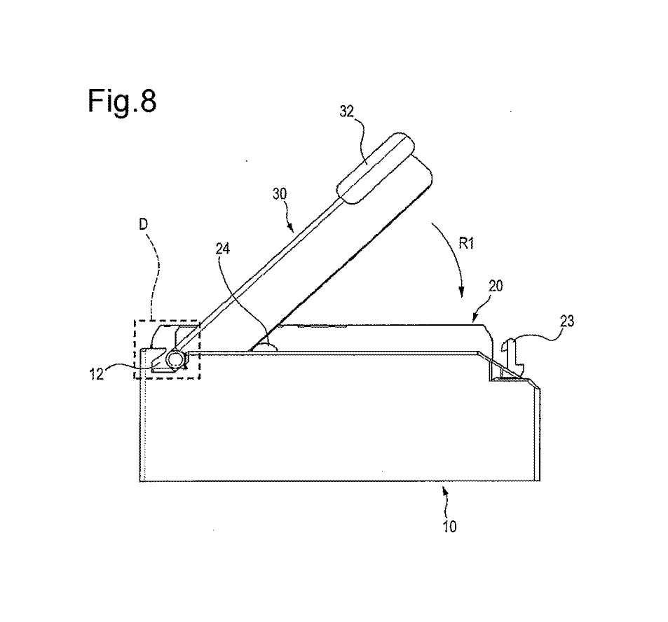

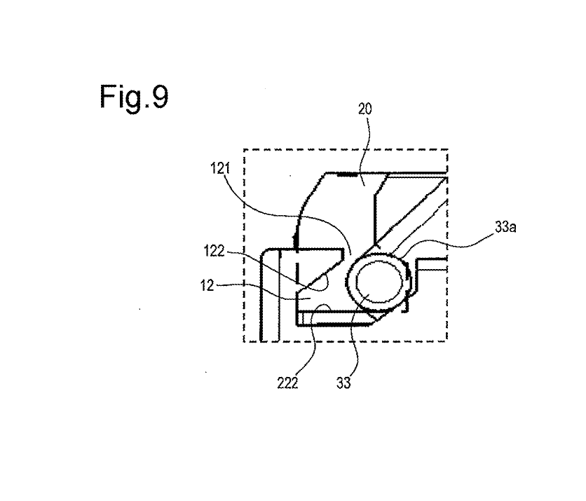

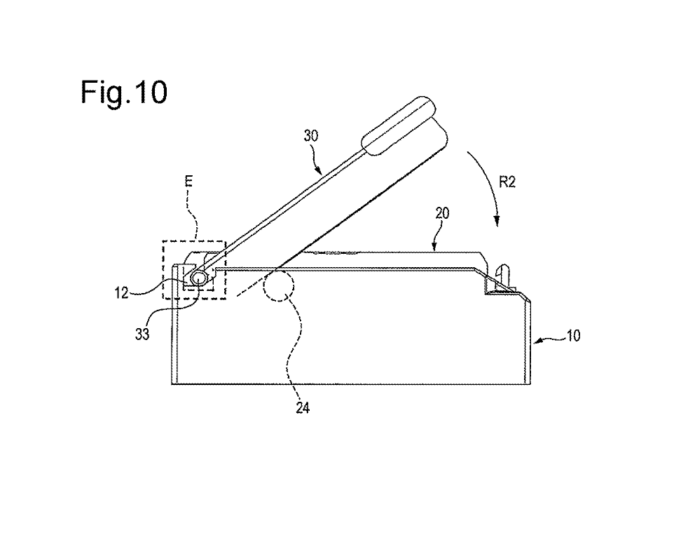

FIG. 1 to FIG. 10 show one exemplary embodiment of a lever type connector according to the present invention. FIG. 1 is an exploded perspective view of a lever type connector of one exemplary embodiment according to the present invention. FIG. 2 is a side view of a first connector housing shown in FIG. 1. FIG. 3 is an enlarged view of a part A shown in FIG. 2. FIG. 4 is a side view of a second connector housing shown in FIG. 1. FIG. 5 is an enlarged view of a part B shown in FIG. 4. FIG. 6 is a side view showing a state that the second connector housing to which a fitting operation lever shown in FIG. 1 is attached is opposed to the first connector housing. FIG. 7 is an enlarged view of a part C shown in FIG. 6. FIG. 8 is a side view showing a state that the first connector housing and the second connector housing shown in FIG. 6 are positioned to a fitting operation start position. FIG. 9 is an enlarged view of a part D shown in FIG. 8. FIG. 10 is a side view when a rotating operation of the fitting operation lever is started from the state shown in FIG. 8 and a second inclined surface 222b of a second support recessed part moves a fulcrum shaft of the fitting operation lever to a first shaft guide surface of a first support recessed part.

The lever type connector 1 of one exemplary embodiment includes, as shown in FIG. 1, a first connector housing 10, a second connector housing 20 fitted and connected to the first connector housing 10 and a fitting operation lever 30 rotatably attached to the first connector housing 10.

The first connector housing 10 includes an outer tubular wall part 11, first support recessed parts 12 and a locking engagement part 13.

The outer tubular wall part 11 has structure in the shape of a rectangular tube fitted to an outer periphery of the second connector housing 20 in an end side part of the first connector housing 10.

The first support recessed parts 12 are cut out and formed on end edges 111 of one pair of side walls 11a and 11a of the outer tubular wall part 11 which are opposed to each other. Positions where the first support recessed parts 12 are formed are located in one end side (a left end side in FIG. 2) of a direction (a direction shown by an arrow mark Y2 in FIG. 1 and FIG. 2) which intersects at right angles to a direction (a direction shown by an arrow mark X2 in FIG. 1) where the one pair of side walls 11a and 11a are opposed to each other.

The first support recessed parts 12 are cut-out parts into which outer end parts 33a of fulcrum shafts 33 of the below-described fitting operation lever 30 can be inserted. In the first support recessed part 12, an opening part 121 which allows the outer end part 33a of the fulcrum shaft 33 of the below-described fitting operation lever 30 to go in and out is opened toward a fitting direction to the second connector housing 20 (a direction shown by an arrow mark Z2 in FIG. 1 and FIG. 2).

The first support recessed part 12 has, as shown in FIG. 3, a first shaft guide surface 122 in its interior.

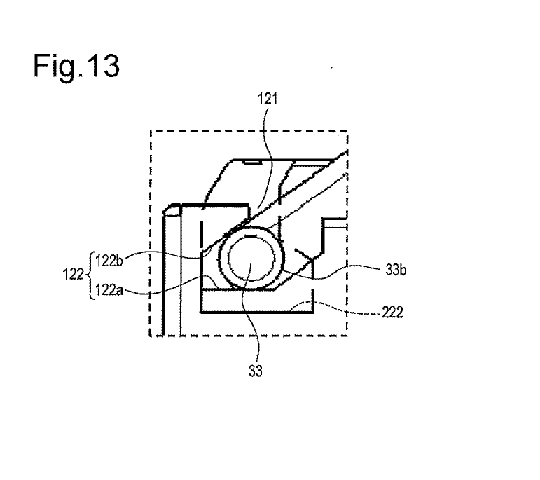

The first shaft guide surface 122 is a surface on which the fulcrum shaft 33 of the fitting operation lever 30 rotatably abuts as shown in FIG. 13. As shown in FIG. 3, the first shaft guide surface 122 includes a first abutting surface 122a and a first inclined surface 122b.

The first abutting surface 122a is a surface which extends in a direction (a direction shown by an arrow mark Y3 shown in FIG. 3) intersecting at right angles to the fitting direction of the connector housings. When the fulcrum shaft 33 abuts on the first abutting surface 122a, the first abutting surface 122a regulates a movement of the fulcrum shaft 33 toward the fitting direction.

The first inclined surface 122b is a surface which extends in a direction (a direction shown by an arrow mark Q3 in FIG. 3) inclined relative to the fitting direction of the connector housings. When the fulcrum shaft 33 abuts on the first inclined surface 122b, the first inclined surface 122b regulates a movement of the fulcrum shaft 33 toward the direction intersecting at right angles to the fitting direction.

When the fitting operation lever 30 receives a rotating and operating force in a prescribed direction, the first shaft guide surface 122 supports the fulcrum shaft 33 of the fitting operation lever 30 which abuts on the first shaft guide surface 122 as a supporting point of rotation of a lever and allows lever main bodies 31 of the fitting operation lever 30 to function as lever members.

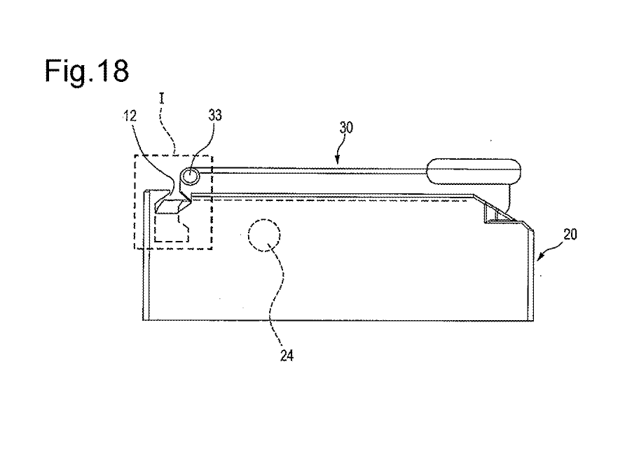

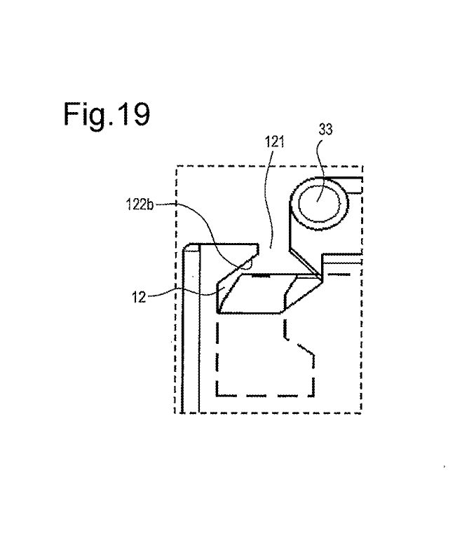

Further, when the connector housings are completely fitted and connected to each other by a rotating operation of the fitting operation lever 30, the first inclined surface 122b operates to move the fulcrum shaft 33 toward the opening part 121 and push the fulcrum shaft 33 outside the first support recessed part 12 and detaches the fitting operation lever 30 from the connector housings 10 and 20 as shown in FIG. 18 and FIG. 19.

As shown in FIG. 1, the locking engagement part 13 is an engaging protrusion provided in an inner side surface 11b1 of the outer tubular wall part 11. In the case of the present exemplary embodiment, the inner side surface 11b1 in which the locking engagement part 13 is provided is an inner surface of a side wall 11b which connects together the other end sides of the one pair of side walls 11a and 11a. The locking engagement part 13 is engaged with the second connector housing 20 when a fitting and connecting operation of the first connector housing 10 and the second connector housing 20 is completed to lock a connected state of the connector housings.

As shown in FIG. 1, the second connector housing 20 includes second support recessed parts 22, an engagement receiving part 23 and operation receiving boss parts 24.

The second support recessed parts 22 are formed to be recessed on one pair of outer side walls 211 and 211 of a housing main body 21 inserted into the outer tubular wall part 11. The one pair of outer side walls 211 and 211 on which the second support recessed parts 22 are formed are side walls facing inner surfaces of the one pair of side walls 11a and 11a provided with the first support recessed parts 12.

The second support recessed parts 22 are recessed parts formed to be recessed so as to insert inner end parts 33b of the fulcrum shafts 33 of the fitting operation lever 30.

As shown in FIG. 4 and FIG. 5, the second support recessed part 22 is formed to be recessed in a direction (a direction shown by an arrow mark Y4 in FIG. 5) opposed to the first support recessed part 12. Into the second support recessed part 22, the inner end part 33b of the fulcrum shaft 33 of the fitting operation lever 30 can be inserted from a direction shown by an arrow mark Q4 in FIG. 5.

The second support recessed part 22 includes, as shown in FIG. 5, a second shaft guide surface 222 and a detachment guide surface 223.

The second shaft guide surface 222 is, as shown in FIG. 6 and FIG. 7, a surface on which the inner end part 33b of the fulcrum shaft 33 inserted into the second support recessed part 22 rotatably abuts. The second shaft guide surface 222 includes, as shown 5, a second abutting surface 222a and a second inclined surface 222b.

The second abutting surface 222a is a surface extending in the direction (the direction shown by the arrow mark Y4 in FIG. 5) intersecting at right angles to the fitting direction of the connector housings. When the fulcrum shaft 33 abuts on the second abutting surface 222a, a movement of the fulcrum shaft 33 toward the fitting direction is regulated.

The second inclined surface 222b is a surface extending in the direction (the direction shown by the arrow mark Q4 in FIG. 5) inclined to the fitting direction of the connector housings. When the fulcrum shaft 33 abuts on the second inclined surface 222b, a movement of the fulcrum shaft 33 to a direction (a direction shown by an arrow mark Y5 in FIG. 5) intersecting at right angles to the fitting direction is regulated.

As shown in FIG. 6 to FIG. 9, the second support recessed part 22 is arranged in such a way that when the second connector housing 20 is positioned to a fitting operation start position to the first connector housing 10 under a state that the inner end part 33b of the fulcrum shaft 33 of the fitting operation lever 30 is allowed to abut on the second shaft guide surface 222, the outer end part 33a of the fulcrum shaft 33 is inserted into the first support recessed part 12.

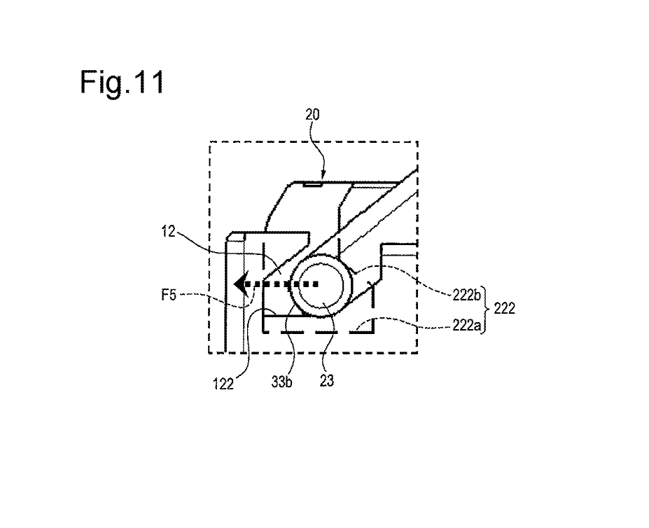

Then, as shown in FIG. 8 and FIG. 9, under a state that the connector housings are positioned to the fitting operation start position, the fitting operation lever 30 the fulcrum shaft 33 of which is engaged with the second support recessed part 22 receives the rotating and operating force in a prescribed direction (a direction shown by an arrow mark R1). Then, when the fitting operation lever 30 rotates on the below-described operation receiving boss parts 24 as supporting points, a pressing load is applied to the second inclined surface 222b on which the inner end part 33b of the fulcrum shaft 33 abuts from the inner end part 33b of the fulcrum shaft 30. The second inclined surface 222b sends out the fulcrum shaft 33 to the first shaft guide surface 122 side as shown by an arrow mark F5 in FIG. 11 due to the pressing load applied from the inner end part 33b of the fulcrum shaft 33, so that the fulcrum shaft 33 rotatably abuts on the first shaft guide surface 122.

When the fitting and connecting operation of the first connector housing 10 and the second connector housing 20 is completed, the engagement receiving part 23 is engaged with the locking engagement part 13 of the first connector housing 10 to lock the connected state of the connector housings. The engagement receiving part 23 includes, as shown in FIG. 4, a spring piece 231 and an engaging protrusion 232.

The spring piece 231 has the form of a leaf spring extending along the fitting direction of the connector housings from an outer side surface 213 of the housing main body 21. Further, the engaging protrusion 232 protrudes on the spring piece 231 so as to be engaged with the locking engagement part 13 when the fitting and connecting operation of the connector housings is completed.

The operation receiving boss parts 24 protrude on surfaces of the one pair of outer side walls 211 and 211 of the housing main body 21. A position where the operation receiving boss part 24 is provided is located at a position spaced by a prescribed distance from the second support recessed part 22 in an extending direction (a direction shown by an arrow mark Y6 in FIG. 4) of the one pair of outer side walls 211 and 211.

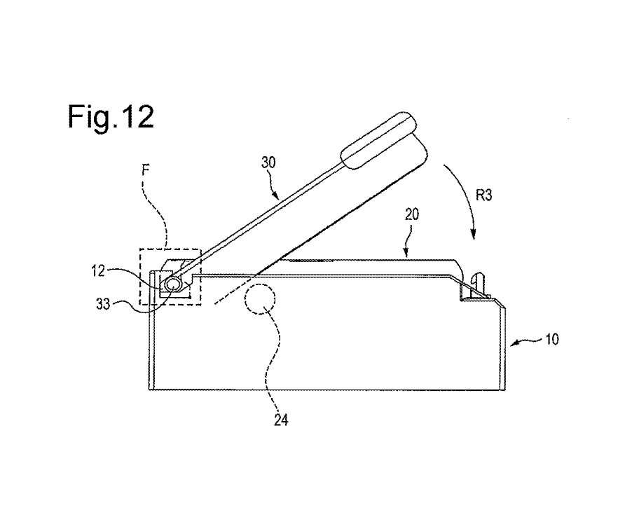

As shown in FIG. 12 to FIG. 17, when the fitting operation lever 30 rotatably supported in the first support recessed part 12 is rotated in a prescribed direction, a side edge of the lever main body 31 of the fitting operation lever 30 abuts on the operation receiving boss part 24. Thus, the operation receiving boss part 24 receives a force in the fitting direction of the connector housings from the fitting operation receiver 30.

The fitting operation lever 30 is rotatably attached to the first connector housing 10 as a lever member that reduces an operating force during a fitting operation and during a releasing operation of a fitted state of the first connector housing 10 and the second connector housing 20.

The fitting operation lever 30 includes, as shown in FIG. 1, one pair of lever main bodies 31, a rotating and operating part 32 and the fulcrum shafts 33.

The one pair of lever main bodies 31 and 31 are rod shaped members arranged to be opposed to each other so as to be inserted into gaps between the one pair of side walls 11a and 11a of the first connector housing 10 and the one pair of outer side walls 211 and 211 of the second connector housing 20.

The rotating and operating part 32 connects base end sides of the one pair of lever main bodies 31 and 31 together. The rotating and operating part 32 is a part serving as an operating part when the one pair of lever main bodies 31 and 31 are rotated.

The fulcrum shafts 33 are respectively formed integrally with ends of the lever main bodies 31. The fulcrum shaft 33 includes the outer end part 33a and the inner end part 33b.

The outer end part 33a is a shaft part which protrudes toward the side wall 11a of the first connector housing 10 from the end of the lever main body 31 so as to be inserted into the first support recessed part 12.

The inner end part 33b is a shaft part which protrudes toward the outer side wall of the second connector housing 20 from the end of the lever main body 31 so as to be inserted into the second support recessed part 22.

When the one pair of lever main bodies 31 and 31 of the fitting operation lever 30 are rotated in a prescribed direction (a direction R in FIG. 1) on the first support recessed parts 12 as supporting points with the ends (the fulcrum shafts 33) rotatably supported by the first support recessed parts 12, the side edges of the lever main bodies 31 abut on the operation receiving boss parts 24 of the second connector housing 20 which is attached to the first connector housing 10 to apply the force in the fitting direction of the connector housings thereto.

Further, under a state that the ends (the inner end parts 33b of the fulcrum shafts 33) are inserted into the second support recessed parts 22 of the second connector housing 20, the one pair of lever main bodies 31 and 31 are attached to the first connector housing 10 together with the second support recessed parts 22.

In the lever type connector 1 of the present exemplary embodiment, as an operating procedure for fitting and connecting the connector housings to each other, initially, as shown in FIG. 6 and FIG. 7, the inner end part 33b of the fulcrum shaft 33 of the fitting operation lever 30 is inserted into the second support recessed part 22 of the second connector housing 20 to attach the fitting operation lever 30 to the connector housing 20.

As shown in FIG. 6 and FIG. 7, when the inner end part 33b is allowed to abut on the second shaft guide surface 222 of the second support recessed part 22 and the side edge of the lever main body 31 is allowed to abut on the operation receiving boss part 24, the fitting operation lever 30 is supported by the second connector housing 20.

Then, as shown in FIG. 8 and FIG. 9, the second connector housing 20 to which the fitting operation lever 30 is attached and the first connector housing 10 are positioned to the fitting operation start position.

Then, the outer end part 33a of the fulcrum shaft 33 of the fitting operation lever 30 is inserted into the first support recessed part 12 of the first connector housing 10. However, at that time, the outer end part 33a of the fulcrum shaft 33 is separated from the first shaft guide surface 122 as shown in FIG. 9.

Then, as shown in FIG. 10 and FIG. 11, when the fitting operation lever 30 is started to rotate in a prescribed direction (a direction shown by an arrow mark R2 in FIG. 10), the fitting operation lever 30 swings on the operation receiving boss part 24 provided on the second connector housing 20 as a supporting point on which the side edge of the lever main body 31 abuts. At that time, the second inclined surface 222b of the second shaft guide surface 222 which receives an operating force from the fulcrum shaft 33 sends out the fulcrum shaft 33 to the first shaft guide surface 122 of the first support recessed part 12 opposed thereto as shown by the arrow mark F5 in FIG. 11. In accordance with the sending operation by the second inclined surface 222b, as shown in FIG. 12 and FIG. 13, the fulcrum shaft 33 rotatably abuts on the first shaft guide surface 122.

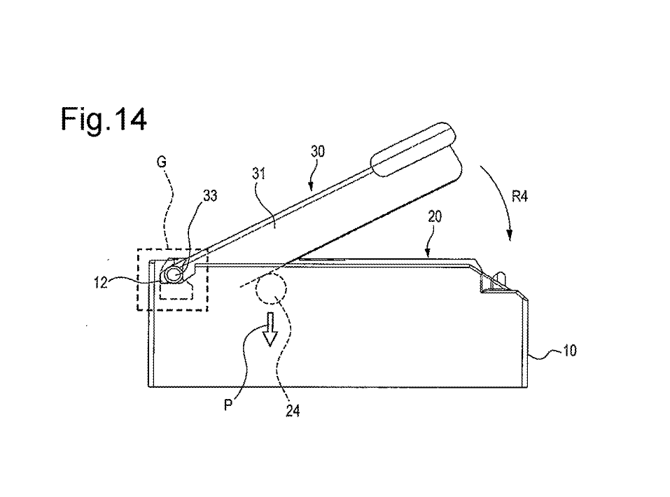

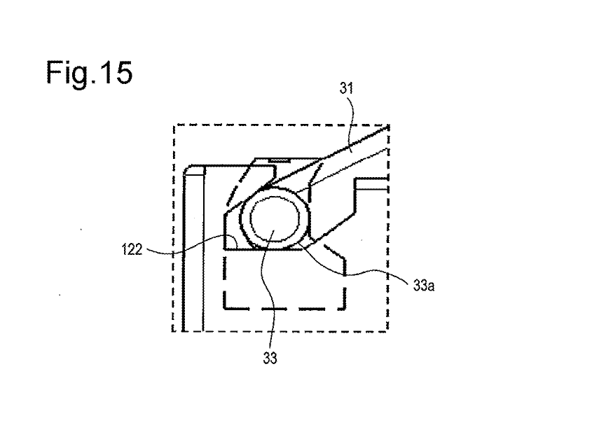

Accordingly, the fitting operation lever 30 operates as a lever having the first shaft guide surface 122 of the first support recessed part 12 as a supporting point of rotation by the operating force inputted to the fitting operation lever 30 and applies the force P in the fitting direction to the operation receiving boss part 24 on the second connector housing 20 as shown in FIG. 14 and FIG. 15 to fit and connect the connector housings to each other.

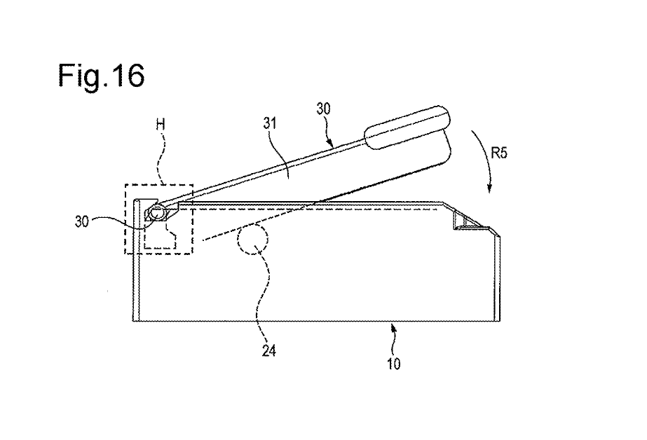

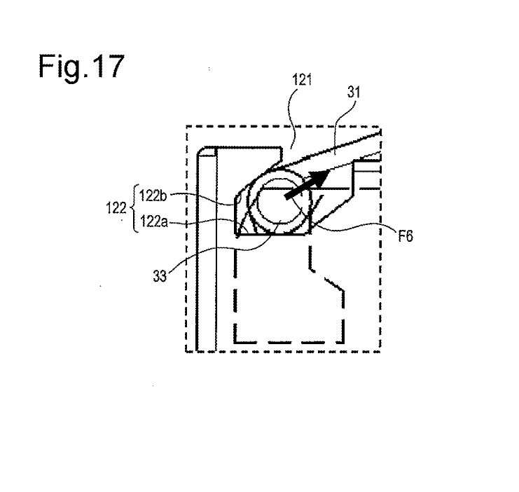

Then, as shown in FIGS. 16 and 17, when the fitting and connecting operation of the connector housings is completed by the rotating operation of the fitting operation lever 30, the engagement receiving part 23 of the second connector housing 20 is engaged with the locking engagement part 13 of the first connector housing 10 to lock the fitted and connected state of the connector housings.

After the connector housings are completely fitted and connected to each other, further as shown in FIG. 16, when the fitting operation lever 30 is rotated in a direction shown by an arrow mark R5, the fulcrum shaft 33 of the fitting operation lever 30 moves toward the opening part 121 side along the first inclined surface 122b of the first support recessed part 12 as shown by an arrow mark F6 in FIG. 17. In accordance with a movement along the first inclined surface 122b, as shown in FIG. 18 and FIG. 19, the fulcrum shaft 33 is sent outside the first support recessed part 12. Thus, the fitting operation lever 30 is detached from the connector housing.

Namely, according to the lever type connector 1 of the present exemplary embodiment, after the fitting and connecting operation of the connector housings is completed by the rotating operation of the fitting operation lever 30, the fitting operation lever 30 is further pressed to the rotating direction, so that the fitting operation lever 30 is automatically detached from the connector housings. Accordingly, under a state that the connector is used, the weight of the fitting operation lever 30 is not applied. Thus, the weight of the connector can be reduced when the connector is used.

Further, since the fitting operation lever 30 detached from the connector housings can be properly used for fitting operations of other lever type connectors 1. Accordingly, as a parts set of an ordinary fitting operation lever 30, only the first connector housing 10 and the second connector housing 20 are used by excluding the fitting operation lever 30. Thus, a cost can be reduced due to a decrease of the number of parts.

The present invention is not limited to the above-described exemplary embodiment, and may be suitably modified and improved. In addition thereto, materials, forms, dimensions, numbers and arranged positions or the like of component elements in the above-described exemplary embodiment may be arbitrary and are not limited as long as they can achieve the present invention.

For instance, in the present exemplary embodiment, the number of provision of the locking engagement part 13 and the engagement receiving part 23 is respectively set to one. However, the locking engagement parts 13 and the engagement receiving parts 23 may be provided at a plurality of positions to lock a connected state of the connector housings in a plurality of engagement parts.

The present application is based on Japanese Patent Application No. 2012-107891 filed on May 9, 2012, the contents of which are incorporated herein by reference.

### INDUSTRIAL APPLICABILITY

According to the lever type connector of the present invention, after the fitting and connecting operation of the connector housings is completed, the fitting operation lever is detached from the connector housings. Accordingly, under a state that the connector is used, the weight of the connector can be reduced.

Further, since the fitting operation lever detached from the connector housings can be properly used for fitting operations of other lever type connectors. Accordingly, as a parts set of an ordinary fitting operation lever, only the first connector housing and the second connector housing are used by excluding the fitting operation lever. Thus, a cost can be reduced due to a decrease of the number of parts.

### REFERENCE SIGNS LIST

1 . . . lever type connector
10 . . . first connector housing
11 . . . outer tubular wall part
11a . . . side wall
11b1 . . . inner side surface
12 . . . first support recessed part
13 . . . locking engagement part
20 . . . second connector housing
22 . . . second support recessed part
23 . . . engagement receiving part
24 . . . operation receiving boss part
30 . . . fitting operation lever
33 . . . fulcrum shaft
33a . . . outer end part
33b . . . inner end part
111 . . . end edge
122 . . . first shaft guide surface
122b . . . first inclined surface
211 . . . outer side wall
222 . . . second shaft guide surface
222b . . . second inclined surface

1. A lever type connector, comprising:
a first connector housing;
a second connector housing fitted and connected to the first connector housing; and
a fitting operation lever rotatably attached to the first connector housing as a lever member which reduces an operation force during a fitting operation and a releasing operation of a fitted state of the first connector housing and the second connector housing;
wherein the first connector housing includes:
an outer tubular wall part fitted to an outer periphery of the second connector housing;
first support recessed parts formed and cut out so as to insert therein outer end parts of fulcrum shafts of the fitting operation lever in one end sides in a direction intersecting at right angles to a direction where one pair of side walls are opposed to each other on end edges of the one pair of side walls of the outer tubular wall part which are opposed to each other, the first support recessed parts having in their interiors first shaft guide surfaces on which the inserted fulcrum shafts rotatably abut; and
a locking engagement part provided on one or a plurality of inner side surfaces of the outer tubular wall part and engaged with the second connector housing when a fitting and connecting operation of the first connector housing and the second connector housing is completed to lock the connected state of the connector housings,
the second connector housing includes:
second support recessed parts formed to be recessed so as to insert therein inner end parts of the fulcrum shafts of the fitting operation lever on one pair of outer side walls which face inner surfaces of the one pair of side walls provided with the first support recessed parts, having second shaft guide surfaces formed to be recessed in directions opposed to the first support recessed parts on which the inner end parts of the inserted fulcrum shafts rotatably abut, and in which when the second connector housing is positioned to a fitting operation start position to the first connector housing under a state that the inner end parts of the fulcrum shafts are allowed to abut on the second shaft guide surfaces, the outer end parts of the fulcrum shafts are inserted into the first support recessed parts;
an engagement receiving part engaged with the locking engagement part when the fitting and connecting operation of the first connector housing and the second connector housing is completed to lock the connected state of the connector housings; and
operation receiving boss parts protruding at positions spaced by prescribed distances from the second support recessed parts in a direction intersecting at right angles to a direction where the one pair of outer side walls are opposed to each other on surfaces of the one pair of outer side walls, and on which side edges of lever main bodies of the fitting operation lever abut when the fitting operation lever rotatably supported in the first support recessed parts is rotated in a prescribed direction to receive a force in a fitting direction of the connector housings from the fitting operation lever;
the fitting operation lever includes:
one pair of lever main bodies arranged and opposed to each other so as to be inserted into gaps between the one pair of side walls of the first connector housing and the one pair of outer side walls of the second connector housing, and having their side edges abutting on the operation receiving boss parts of the second connector housing attached to the first connector housing when the lever main bodies are rotated in a prescribed direction on the first support recessed parts as supporting points with ends rotatably supported by the first support recessed parts to apply the force in the fitting direction of the connector housings; and
the fulcrum shafts including the outer end parts protruding toward the side walls of the first connector housing from the ends of the lever main bodies so as to be inserted into the first support recessed parts and the inner end parts protruding toward the outer side walls of the second connector housing from the ends of the lever main bodies so as to be inserted into the second support recessed parts,
the second shaft guide surfaces in the second support recessed parts have second inclined surfaces which send out the fulcrum shafts to the first shaft guide surfaces by a force applied to abutting parts from the inner end parts of the fulcrum shafts when the fitting operation lever receives a rotating and operating force in a prescribed direction and rotates on the operation receiving boss parts as supporting points to allow the fulcrum shafts to rotatably abut on the first shaft guide surfaces, and
the first shaft guide surfaces of the first support recessed parts have first inclined surfaces which support the fulcrum shafts as supporting points of rotation of levers and allow the lever main bodies to function as lever members when the fitting operation lever receives a rotating and operating force in a prescribed direction, and send out the fulcrum shafts outside the first support recessed parts in accordance with a rotation applied to the fitting operation lever after the fitting and connecting operation of the connector housings is completed by the rotating operation of the fitting operation lever to detach the fitting operation lever from the first connector housing.
